(19) United States
(12) Patent Application Publication
(10) Pub. No.: US 2016/0238849 A1
(43) Pub. Date: Aug. 18, 2016

(54) LIGHT GUIDE PRISM AND HEAD-MOUNTED DISPLAY APPARATUS

(71) Applicant: OLYMPUS CORPORATION, Tokyo (JP)

(72) Inventors: Ryohei SUGIHARA, Tokyo (JP); Shinya TAKAHASHI, Tokyo (JP)

(73) Assignee: OLYMPUS CORPORATION, Tokyo (JP)

(21) Appl. No.: 15/142,102

(22) Filed: Apr. 29, 2016

Related U.S. Application Data
(63) Continuation of application No. PCT/JP2013/006440, filed on Oct. 30, 2013.

(51) Int. Cl. G02B 27/01; G02B 7/18; G02B 5/04

(52) U.S. Cl. CPC G02B 27/0172; G02B 5/04; G02B 27/0176; G02B 7/1805; G02B 2027/0143; G02B 2027/0178

(57) ABSTRACT

A light guide prism that is used by being placed in front of a user's eye and guides image light from a display device to the user's eye for observation as a virtual image includes a first light-guiding portion, a second light-guiding portion, and a level difference positioned between the first light-guiding portion and the second light-guiding portion. In a state of use in front of the user's eye, the second light-guiding portion is positioned at a front side of the user's eye, the first and second light-guiding portions each have uniform thickness, a vertical thickness of the second light-guiding portion being less than a vertical thickness of the first light-guiding portion with the level difference as a boundary, and the level difference extends at an inclination with respect to an exit optical axis of the light guide prism so as not to enter the user's field of view.

### CROSS-REFERENCE TO RELATED APPLICATION

The present application is a Continuing Application based on International Application PCT/JP2013/006440 filed on Oct. 30, 2013, the entire disclosure of which is incorporated herein by reference.

### TECHNICAL FIELD

This disclosure relates to a light guide prism and a head-mounted display apparatus that guide image light for observation of a virtual image.

### BACKGROUND

In recent years, a light guide prism (eyepiece optical unit) that guides image light from a small display device and enlarges the image light with a lens for observation as a virtual image has been proposed (for example, see JP 2012-203113 A (PTL 1)). Such a compact, lightweight light guide prism can be used as a wearable display by being mounted on a device that can be worn on the head.

The light guide prism disclosed in PTL 1 is formed so that, in a state of use in front of the user's eye, the vertical thickness is uniform at the side of the entrance portion for image light, whereas the exit portion side is a tapered shape such that the vertical thickness becomes thinner from the entrance portion towards the exit portion. This light guide prism is advantageous in that the exit portion side can be made compact, thereby guaranteeing the user's external field of view. This structure is also advantageous in that the side at the entrance portion for image light can be made thicker, thereby making it easier to guarantee an effective diameter for the image light, to attach a display device to the entrance portion, to guarantee a portion for securing to the housing, and to guarantee a gate space when injection molding the light guide prism.

### CITATION LIST

### Patent Literature

PTL 1: JP 2012-203113 A

### SUMMARY

As a tapered light guide prism, for example the light guide prism 100 illustrated in the front view and the plan view of FIGS. 5A and 5B is envisioned. The light guide prism 100 includes an entrance portion 121, a reflecting portion 122, and an exit portion 123. The exit portion 123 is configured with an eyepiece. In a state of use in front of the user's eye, the light guide prism 100 guides image light, from a display device 200, that is incident on the entrance portion 121 to reflect the image light once at the reflecting portion 122 and emit the image light from the exit portion 123 towards the user's eye, allowing the user to observe the image light as a virtual image.

In a state of use in front of the user's eye, the light guide prism 100 illustrated in FIGS. 5A and 5B has a uniform vertical thickness at the entrance portion 121 side and has a tapered shape at the exit portion 123 side. Therefore, the middle portion becomes thicker and correspondingly bulkier as compared to the case illustrated by the phantom lines in FIG. 5A, in which the entrance portion 121 side and the exit portion 123 side each have a uniform vertical thickness, and a step-like level difference is formed by the thickness at the exit portion 123 side being less than the thickness at the entrance portion 121 side. Accordingly, in order to achieve a thinner, lighter light guide prism, the light guide prism 100 could be formed to have a step-like level difference as illustrated by the phantom lines in FIG. 5A.

FIGS. 6A and 6B respectively illustrate a front view and a plan view of a light guide prism 101 formed to have a level difference. In FIGS. 6A and 6B, the light guide prism 101 includes a level difference 124 between the entrance portion 121 and the reflecting portion 122. The entrance portion 121 side and the reflecting portion 122 and exit portion 123 side each have a uniform vertical thickness, and with the level difference 124 as a boundary, the thickness at the reflecting portion 122 and exit portion 123 side becomes less than the thickness at the entrance portion 121 side.

As illustrated in FIG. 6B, however, when the extending direction of the level difference 124 is nearly parallel to the exit optical axis Oₑ of the light guide prism in a top view in the state of use, i.e. when the level difference 124 extends in a direction orthogonal to the longitudinal direction of the light guide prism 101, outside light or the like that is reflected at the level difference 124 enters the user's eye E. Therefore, the level difference 124 may enter the user's field of view and cause a sense of discomfort. The same sort of problem also occurs in a head-mounted display apparatus in which a light guide prism is held in a housing.

A light guide prism according to an aspect of this disclosure is used by being placed in front of a user's eye and guides image light from a display device to the user's eye for observation as a virtual image, the light guide prism including:

a first light-guiding portion, a second light-guiding portion, and a level difference positioned between the first light-guiding portion and the second light-guiding portion, such that

in a state of use in front of the user's eye,
the second light-guiding portion is positioned at a front side of the user's eye,
with the level difference as a boundary, a vertical thickness of the second light-guiding portion is less than a vertical thickness of the first light-guiding portion, and
the level difference extends at an inclination with respect to an exit optical axis of the light guide prism so as not to enter the user's field of view.

In the light guide prism, in a top view in the state of use, an extension line in an extending direction of the level difference may intersect with the exit optical axis of the light guide prism between the first light-guiding portion and the eye.

In the light guide prism, in a top view in the state of use, an edge of the level difference at an opposite side from an edge of the level difference towards the eye may be positioned closer to entrance of the image light than is an extension line of a line connecting the edge of the level difference towards the eye with the eye.

Furthermore, a head-mounted display apparatus according to an aspect of this disclosure includes:

an eyepiece optical unit, used by being placed in front of a user's eye, that guides image light from a display device to the user's eye for observation as a virtual image; and

a housing holding the eyepiece optical unit, such that

the housing includes a first housing portion, a second housing portion, and a level difference positioned between the first housing portion and the second housing portion, and

in a state of use in front of the user's eye,
the second housing portion is positioned at a front side of the user's eye,
with the level difference as a boundary, a vertical thickness of the second housing portion is less than a vertical thickness of the first housing portion, and
the level difference extends at an inclination with respect to an exit optical axis of the light guide prism so as not to enter the user's field of view.

In the head-mounted display apparatus, in a top view in the state of use, an edge of the level difference at an opposite side from an edge of the level difference towards the eye may be positioned closer to entrance of the image light than is an extension line of a line connecting the edge of the level difference towards the eye with the eye.

Furthermore, a head-mounted display apparatus according to an aspect of this disclosure includes:

a light guide prism, used by being placed in front of a user's eye, that guides image light from a display device to the user's eye for observation as a virtual image; and

a housing that holds the light guide prism, wherein

the housing holds the light guide prism so that a portion of the light guide prism is exposed, and

in a state of use in front of the user's eye,
the portion of the light guide prism exposed from the housing is positioned at a front side of the eye, and
an end face of the housing has an opening exposing the light guide prism, and the end face is inclined with respect to an exit optical axis of the light guide prism so as not to enter the user's field of view.

In the head-mounted display apparatus, in a top view in the state of use, an edge of the end face at an opposite side from an edge of the end face towards the eye may be positioned closer to entrance of the image light than is an extension line of a line connecting the edge of the end face towards the eye with the eye.

### BRIEF DESCRIPTION OF THE DRAWINGS

In the accompanying drawings:

FIG. 1A is a front view illustrating the main structure of a light guide prism according to Embodiment 1 of this disclosure, and FIG. 1B is a plan view of the light guide prism in FIG. 1A;

FIG. 2A is a front view schematically illustrating the main structure of the head-mounted display apparatus according to Embodiment 2 of this disclosure, and FIG. 2B is a plan view of the head-mounted display apparatus in FIG. 2A;

FIG. 3A is a front view schematically illustrating the main structure of the head-mounted display apparatus according to Embodiment 3 of this disclosure, and FIG. 3B is a plan view of the head-mounted display apparatus in FIG. 3A;

FIG. 4 is a perspective view illustrating a usage example of the head-mounted display apparatus according to this disclosure;

FIG. 5A is a front view illustrating the main structure of a tapered light guide prism, and FIG. 5B is a plan view of the light guide prism in FIG. 5A; and

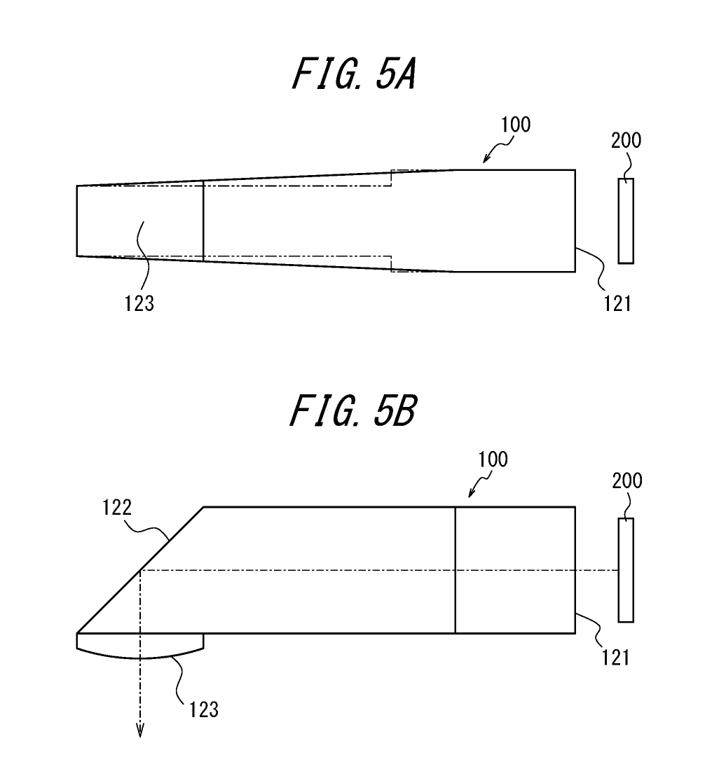

FIG. 6A is a front view illustrating the main structure of a conventionally envisioned light guide prism with a level difference, and FIG. 6B is a plan view of the light guide prism in FIG. 6A.

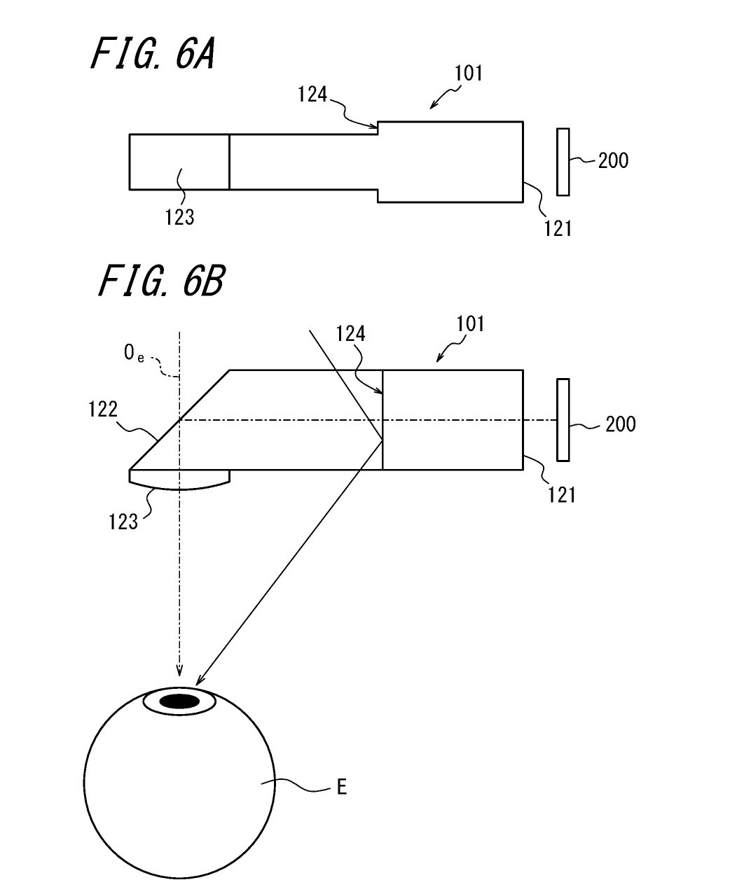

### DETAILED DESCRIPTION

The following describes embodiments with reference to the drawings.

### Embodiment 1

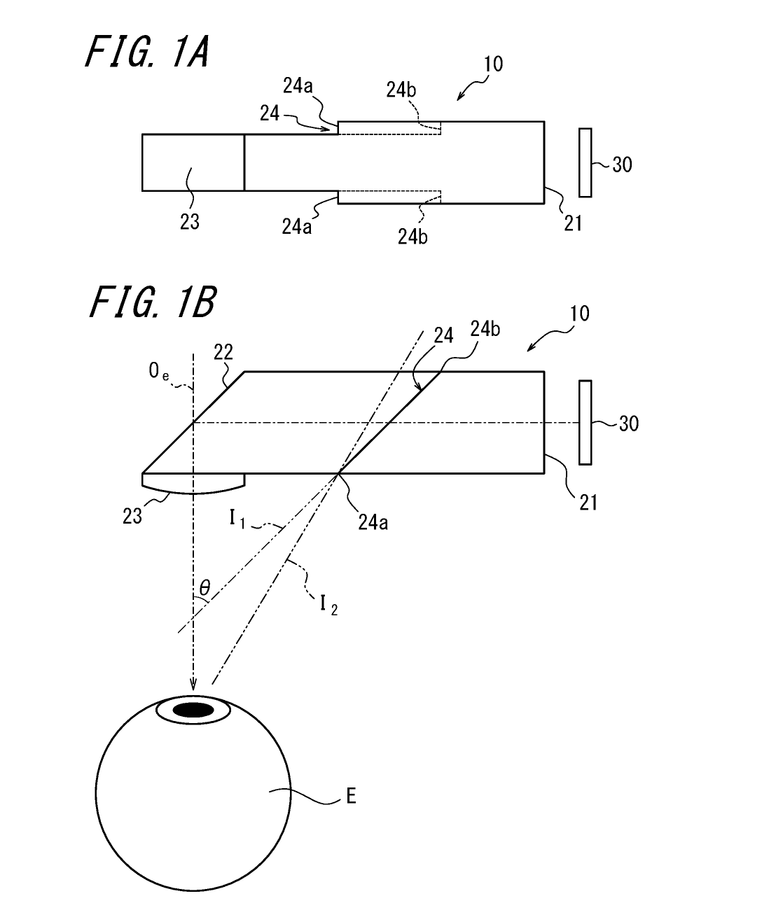

FIGS. 1A and 1B are a front view and a plan view illustrating the main structure of a light guide prism according to Embodiment 1 of this disclosure. The light guide prism 10 according to this embodiment includes an entrance portion 21, a reflecting portion 22, an exit portion 23, and a level difference 24. The exit portion 23 is configured with an eyepiece. In a state of use in front of the user's eye, the light guide prism 10 guides image light, from a display device 30, that is incident on the entrance portion 21 to reflect the image light once at the reflecting portion 22 and emit the image light from the exit portion 23 towards the user's eye E, allowing the user to observe the image light as a virtual image. In the state of use, the level difference 24 is formed on both the upper surface and the lower surface.

In the light guide prism 10 of this embodiment, the vertical thickness in the state of use is uniform on the side of the entrance portion 21, which constitutes a first light-guiding portion, and on the side of the reflecting portion 22 and the exit portion 23, which constitute a second light-guiding portion, with the level difference 24 as a boundary therebetween, and the thickness at the side of the reflecting portion 22 and the exit portion 23 is less than the thickness at the side of the entrance portion 21. In other words, the level difference 24 is formed as a step. In the state of use, the second light-guiding portion that includes the reflecting portion 22 and the exit portion 23 is positioned at the front side of the user's eye E. In the state of use, the level difference 24 extends at an inclination with respect to the exit optical axis Oₑ of the light guide prism, so as not to enter the user's field of view. In other words, the level difference 24 extends at an inclination with respect to the user's visual axis.

Therefore, in this embodiment, the level difference 24 is formed so that in a top view in the state of use, an extension line I₁ in the extending direction of the level difference 24 intersects with the exit optical axis Oₑ of the light guide prism between the exit portion 23 and the eye E. In other words, in a top view in the state of use, an edge 24b of the level difference 24 at the opposite side from an edge 24a by the eye E is positioned closer to the entrance portion 21 than is an extension line I₂ of a line connecting the edge 24a with the eye E.

The distance from the exit portion 23 to the eye E in the state of use of the light guide prism 10 is, for example, approximately 15 mm to 25 mm, and the left-to-right length of the light guide prism 10 is, for example, approximately 24 mm to 30 mm. The level difference 24 is preferably formed in the middle portion. Accordingly, the angle θ between the exit optical axis Oₑ and the extension line I₁ is, for example, preferably 25° or greater. The level difference 24 may be a right angle with respect to the surface of the entrance portion 21 side and the exit portion 23 side or may be slightly inclined.

With the light guide prism 10 of this embodiment, the level difference 24 is formed to be inclined with respect to the exit optical axis Oₑ of the light guide prism so as not to enter the user's field of view in the state of use. Hence, the discomfort experienced in the user's field of view can be reduced. Furthermore, since the level difference 24 is formed as a step, the reflecting portion 22 and exit portion 23 side can be made thinner and lighter.

### Embodiment 2

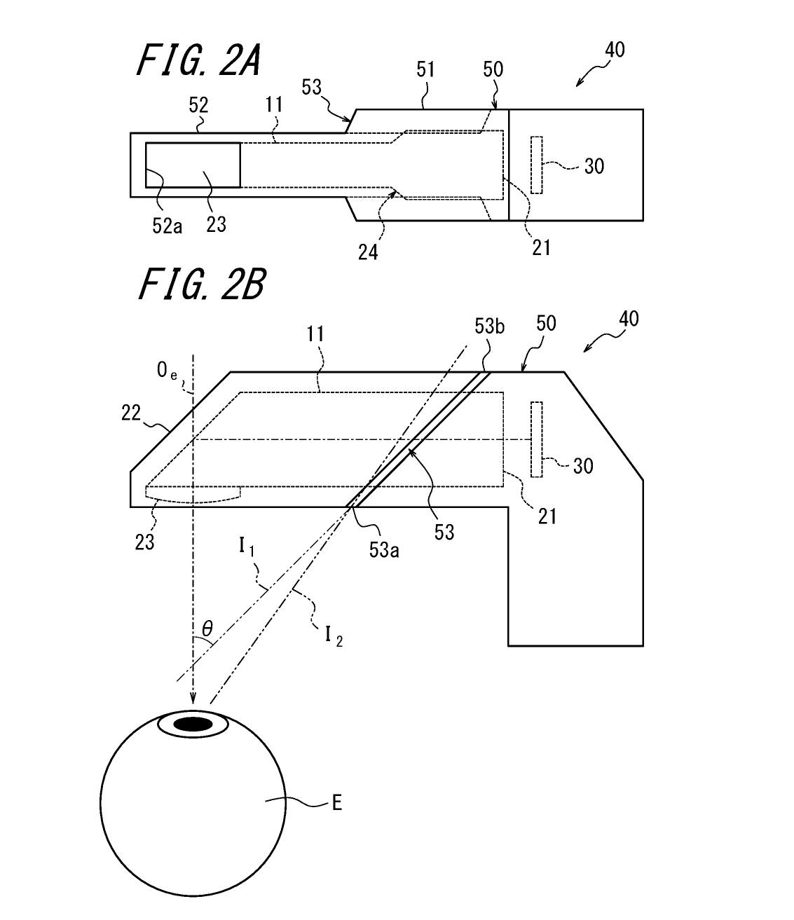

FIGS. 2A and 2B are a front view and a plan view schematically illustrating the main structure of a head-mounted display apparatus according to Embodiment 2 of this disclosure. A head-mounted display apparatus 40 according to this embodiment includes a housing 50. A light guide prism 11, display device 30, and the like are held in the housing 50, and in a state of use in front of the user's eye, image light from the display device 30 is guided by the light guide prism 11 so as to be emitted towards the user's eye E, allowing the user to observe the image light as a virtual image. The light guide prism 11 may have a known structure. For the sake of convenience, a structure such as the one illustrated in FIGS. 1A and 1B is used here. Accordingly, portions of the light guide prism 11 having the same effects as the constituent elements illustrated in FIGS. 1A and 1B are labeled with the same reference signs, and a description thereof is omitted.

In this embodiment, the housing 50 includes a first housing portion 51, a second housing portion 52, and a level difference 53. In the state of use, the second housing portion 52 is positioned at the front side of the user's eye E. In the state of use, the vertical thickness of the first housing portion 51 and of the second housing portion 52 is uniform with the level difference 53 as a boundary, and the thickness of the second housing portion 52 is less than the thickness of the first housing portion 51. In other words, the level difference 53 is formed as a step. In the state of use, the level difference 53 is formed on both the upper surface and the lower surface. In the state of use, the level difference 53 extends at an inclination with respect to the exit optical axis Oₑ of the light guide prism, so that outside light reflected at the level difference 53 does not enter the user's eye E, i.e. so that the level difference 53 does not enter the user's field of view.

So that the level difference 24 of the light guide prism 11 is positioned at the level difference 53 in the housing 50, the entrance portion 21 side of the light guide prism 11, the display device 30, and the like are held in the first housing portion 51, and the reflecting portion 22 and exit portion 23 side of the light guide prism 11 is held in the second housing portion 52. An opening 52a for emitting image light is formed in the second housing portion 52 in correspondence with the exit portion 23 of the light guide prism 11. In this embodiment, the level difference 53 of the housing 50 and the level difference 24 of the light guide prism 11 are formed at an inclination with respect to the adjacent surface but may be perpendicular instead.

Like the light guide prism 10 of Embodiment 1, the level difference 53 of the housing 50 is formed so that in a top view in the state of use, an extension line I₁ in the extending direction of the level difference 53 intersects with the exit optical axis Oₑ of the light guide prism between the opening 52a and the eye E. In other words, in a top view in the state of use, an edge 53b of the level difference 53 at the opposite side from an edge 53a by the eye E is positioned closer to the entrance portion 21 of the light guide prism 11 than is an extension line I₂ of a line connecting the edge 53a with the eye E. The angle θ between the exit optical axis Oₑ and the extension line I₁ is, for example, preferably 25° or greater, as in the case of Embodiment 1.

Accordingly, with this embodiment, outside light reflected at the level difference 53 does not enter the user's eye E in the state of use. Hence, the discomfort experienced in the user's field of view can be reduced. Furthermore, since the level difference 53 is formed as a step, the second housing portion 52 can be made thinner and lighter than when the second housing portion 52 is formed in a tapered shape.

### Embodiment 3

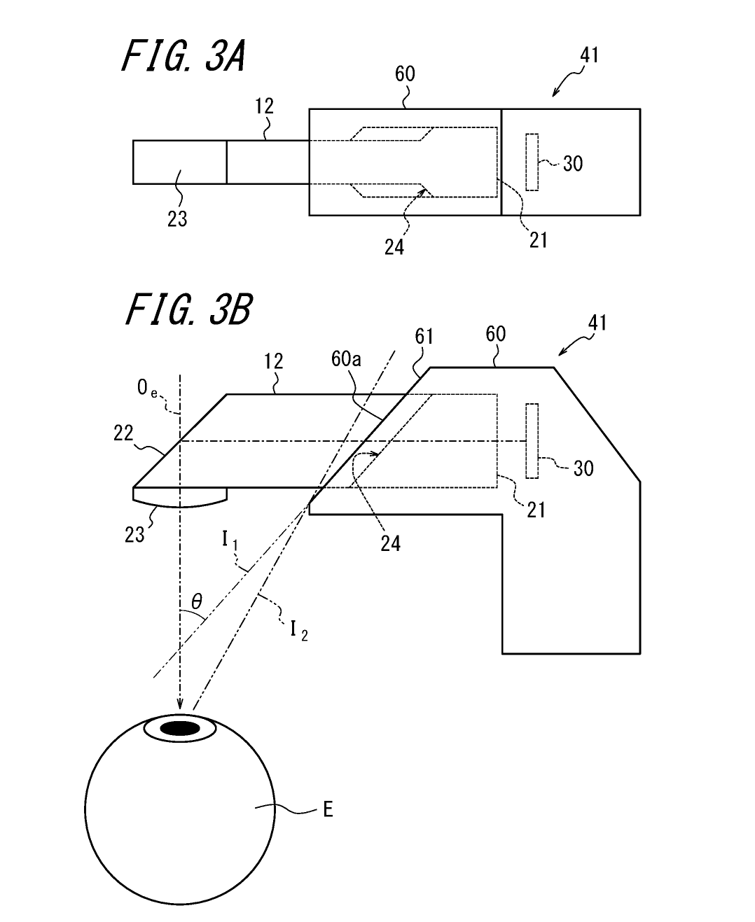

FIGS. 3A and 3B are a front view and a plan view schematically illustrating the main structure of a head-mounted display apparatus according to Embodiment 3 of this disclosure. A head-mounted display apparatus 41 according to this embodiment includes a housing 60. A light guide prism 12, display device 30, and the like are held in the housing 60, and in a state of use in front of the user's eye, image light from the display device 30 is guided by the light guide prism 12 so as to be emitted towards the user's eye E, allowing the user to observe the image light as a virtual image. The light guide prism 12 may have a known structure. For the sake of convenience, a structure such as the one illustrated in FIGS. 1A and 1B is used here. Accordingly, portions of the light guide prism 12 having the same effects as the constituent elements illustrated in FIGS. 1A and 1B are labeled with the same reference signs, and a description thereof is omitted. In FIGS. 3A and 3B, the level difference 24 of the light guide prism 12 is formed at an inclination with respect to the adjacent surface but may be perpendicular instead.

In this embodiment, the thin reflecting portion 22 and exit portion 23 side, positioned by the user's eye E in the state of use, of the light guide prism 12 is exposed from the housing 60, and the thick entrance portion 21 side that includes the level difference 24 is held in the housing 60. In other words, the portion of the light guide prism 12 that is exposed from the housing 60 is positioned at the front side of the user's eye E in the state of use. Accordingly, the vertical thickness of the housing 60 in the state of use is greater than the vertical thickness at the entrance portion 21 side of the light guide prism 12. An end face 61 of the housing 60 has an opening 60a exposing the light guide prism 12, and in the state of use, the end face 61 is inclined with respect to the exit optical axis Oₑ of the light guide prism, so that outside light reflected at the end face 61 does not enter the user's eye E, i.e. so that the end face 61 does not enter the user's field of view.

Like the light guide prism 10 of Embodiment 1, the end face 61 of the housing 60 is formed so that in a top view in the state of use, an extension line I₁ of the plane of the end face 61 intersects with the exit optical axis Oₑ of the light guide prism between the exit portion 23 of the light guide prism 12 and the eye E. In other words, in a top view in the state of use, an edge 61b of the end face 61 at the opposite side from an edge 61a by the eye E is positioned closer to the entrance portion 21 of the light guide prism 12 than is an extension line I₂ of a line connecting the edge 61a with the eye E. The angle θ between the visual axis Oₑ and the extension line I₁ is, for example, preferably 25° or greater, as in the case of Embodiment 1.

Accordingly, with this embodiment, outside light reflected at the end face 61 does not enter the user's eye E in the state of use. Hence, the discomfort experienced in the user's field of view can be reduced. Furthermore, by holding the light guide prism 12 that has a similar structure to Embodiment 1, the portion of the light guide prism 12 exposed from the housing 60 can be made thinner and lighter.

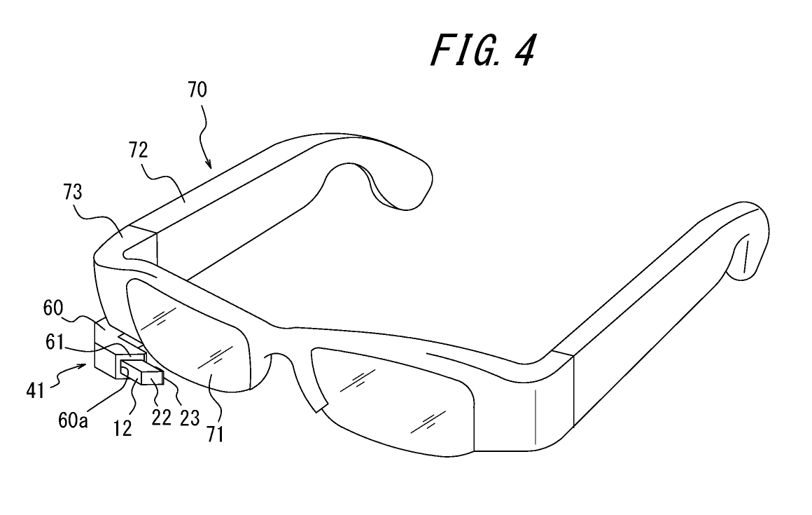

FIG. 4 is a perspective view illustrating a usage example of the head-mounted display apparatus according to this disclosure. FIG. 4 illustrates an example of the head-mounted display apparatus 41 illustrated in FIGS. 3A and 3B being held by eyeglasses 70 and used. The head-mounted display apparatus 41 is configured so that when the user is wearing the eyeglasses 70, the housing 60 is supported by a temple 72, an end piece 73, and the like of the eyeglasses 70 in order to position the light guide prism 12 exposed from the housing 60 in front of one lens 71 of the eyeglasses 70, i.e. in front of one of the user's eyes. Accordingly, in this case, the image light emitted from the light guide prism 12 is guided through the lens 71 to the user's eye, thereby allowing the user to observe a virtual image produced by the image light. The head-mounted display apparatus 40 illustrated in FIGS. 2A and 2B can also be supported similarly by glasses and used.

This disclosure is not limited to the above embodiments, and a variety of changes and modifications may be made. For example, the level difference 24 of the light guide prism 10 illustrated in Embodiment 1 is not limited to being formed on both vertical sides in the state of use and may instead be formed on only the top side or the bottom side. Similarly, the level difference 53 of the housing 50 in the head-mounted display apparatus 40 illustrated in Embodiment 2 is also not limited to being formed on both vertical sides in the state of use and may instead be formed on only the top side or the bottom side. The light guide prism is not limited to a structure such as the one illustrated in the above embodiments that emits image light after reflecting the image light once inside the light guide prism. This disclosure may also be applied effectively to a light guide prism that emits image light after reflecting the light multiple times as in PTL 1. Furthermore, the head-mounted display apparatus of this disclosure is not limited to the case of being supported by the eyeglasses 70 and used as illustrated in FIG. 4 and may instead be supported by a support member in the shape of eyeglasses without lenses, a headset, or the like and used.

### REFERENCE SIGNS LIST

10, 11, 12 Light guide prism

21 Entrance portion

22 Reflecting portion

23 Exit portion

24 Level difference

24a, 24b Edge

30 Display device

40, 41 Head-mounted display apparatus

50 Housing

51 First housing portion

52 Second housing portion

52a Opening

53 Level difference

53a, 53b Edge

60 Housing

60a Opening

61 End face

70 Eyeglasses

1. A light guide prism, used by being placed in front of a user's eye, that guides image light from a display device to the user's eye for observation as a virtual image, the light guide prism comprising:
a first light-guiding portion, a second light-guiding portion, and a level difference positioned between the first light-guiding portion and the second light-guiding portion, wherein
in a state of use in front of the user's eye,
the second light-guiding portion is positioned at a front side of the user's eye,
with the level difference as a boundary, a vertical thickness of the second light-guiding portion is less than a vertical thickness of the first light-guiding portion, and
the level difference extends at an inclination with respect to an exit optical axis of the light guide prism so as not to enter the user's field of view.

2. The light guide prism of claim 1, wherein in a top view in the state of use, an extension line in an extending direction of the level difference intersects with the exit optical axis of the light guide prism between the first light-guiding portion and the eye.

3. The light guide prism of claim 1, wherein in a top view in the state of use, an edge of the level difference at an opposite side from an edge of the level difference towards the eye is positioned closer to entrance of the image light than is an extension line of a line connecting the edge of the level difference towards the eye with the eye.

4. A head-mounted display apparatus comprising:
an eyepiece optical unit, used by being placed in front of a user's eye, that guides image light from a display device to the user's eye for observation as a virtual image; and
a housing holding the eyepiece optical unit, wherein
the housing comprises a first housing portion, a second housing portion, and a level difference positioned between the first housing portion and the second housing portion, and
in a state of use in front of the user's eye,
the second housing portion is positioned at a front side of the user's eye,
with the level difference as a boundary, a vertical thickness of the second housing portion is less than a vertical thickness of the first housing portion, and
the level difference extends at an inclination with respect to an exit optical axis of the light guide prism so as not to enter the user's field of view.

5. The head-mounted display apparatus of claim 4, wherein in a top view in the state of use, an edge of the level difference at an opposite side from an edge of the level difference towards the eye is positioned closer to entrance of the image light than is an extension line of a line connecting the edge of the level difference towards the eye with the eye.

6. A head-mounted display apparatus comprising:
a light guide prism, used by being placed in front of a user's eye, that guides image light from a display device to the user's eye for observation as a virtual image; and
a housing that holds the light guide prism, wherein
the housing holds the light guide prism so that a portion of the light guide prism is exposed, and
in a state of use in front of the user's eye,
the portion of the light guide prism exposed from the housing is positioned at a front side of the eye, and
an end face of the housing has an opening exposing the light guide prism, and the end face is inclined with respect to an exit optical axis of the light guide prism so as not to enter the user's field of view.

7. The head-mounted display apparatus of claim 6, wherein in a top view in the state of use, an edge of the end face at an opposite side from an edge of the end face towards the eye is positioned closer to entrance of the image light than is an extension line of a line connecting the edge of the end face towards the eye with the eye.
